(19) United States
(12) Patent Application Publication
(10) Pub. No.: US 2022/0282412 A1
(43) Pub. Date: Sep. 8, 2022

(54) Press-Bonded Body and Method for Producing the Same

(71) Applicants: VALQUA, LTD., Tokyo (JP); NATIONAL INSTITUTE OF ADVANCED INDUSTRIAL SCIENCE AND TECHNOLOGY, Tokyo (JP)

(72) Inventors: Satomi Kato, Tokyo (JP); Yoshihiro Setoguchi, Tokyo (JP); Takafumi Aizawa, Miyagi (JP)

(21) Appl. No.: 17/629,129

(22) PCT Filed: Jul. 16, 2020
(86) PCT No.: PCT/JP2020/027680

§ 371 Date: Jan. 21, 2022

(30) Foreign Application Priority Data
Aug. 1, 2019 (JP) 2019-141881

(51) Int. Cl. D04H 1/4318; D04H 1/54; D06M 11/76; D06M 15/256

(52) U.S. Cl. CPC D04H 1/4318; D04H 1/54; D06M 11/76; D06M 15/256; D06M 2101/22

(57) ABSTRACT

A press-bonded body or a method for producing the same is provided, such that the press-bonded body is a press-bonded body of at least one of a base material selected from the group consisting of non-woven fabric, stretched porous film, and fiber. The base material contains a fluorine resin (except for polytetrafluoroethylene) having a —CF2- group content of 85% by mass or greater. Polytetrafluoroethylene fibrils bond fibers constitute the base material, and in relation to the entirety of the fibrils, the proportion of the number of fibrils that are oriented at an angle of 45° to 90° relative to the direction of the fibers constituting the base material is 50% or greater.

### CROSS-REFERENCE TO RELATED APPLICATIONS

This application is the United States national phase of International Application No. PCT/JP2020/027680 filed Jul. 16, 2020, and claims priority to Japanese Patent Application No. 2019-141881 filed Aug. 1, 2019, the disclosures of which are hereby incorporated by reference in their entirety.

### BACKGROUND OF THE INVENTION

### Field of the Invention

The present disclosure relates to the field of a press-bonded body or a method for producing the same.

### Description of Related Art

Fluorine resin is a functional polymer that has many superior properties such as excellent heat resistance, chemical resistance, weatherability, and electrical properties, exhibiting non-adhesive surface and a low coefficient of friction.

Base materials comprising at least one selected from non-woven fabric, porous film, and fibers that are made from such fluorine resin are attracting attention, particularly in the fields of medical applications and precision electrical equipment due to their high chemical resistance and favorable electrical properties, for example. However, since fluorine resin-made base materials are made up of non-adhesive polymers and have a low coefficient of friction, the base materials as a whole are inferior in mechanical strength, accompanied by problems for example the frequent falling off of components such as fibers constituting the base materials.

In response to the above problem, Patent Literature 1 (WO 2011/105414 A1) discloses a tetrafluoroethylene-perfluoroalkyl vinyl ether copolymer (PFA) porous sheet made up of a PFA-made filament group comprising a large number of PFA fine particles.

### SUMMARY OF INVENTION

### Technical Problem

The present inventors confirmed that conventional fluorine resin-made porous sheets, particularly conventional press-bonded bodies of at least one selected from non-woven fabric, porous film, and fiber, still have room for improvement in terms of mechanical strength.

In order to, for example, increase mechanical strength and prevent problems the falling off of components such as fibers, the above base materials may also be subjected to thermal fusion (thermal press bonding) at high temperatures exceeding or equal to the melting points thereof. In this case, however, voids contained in the base materials before fusion are eliminated and thereby simple sheets are formed, making it meaningless to use base materials such as non-woven fabric, porous film, and fiber.

In some non-limiting embodiments or aspects, a press-bonded body is provided in an intended shape, exhibiting excellent mechanical strength and having, for example, fibers which hardly fray and base materials which hardly peel off from each other.

### Solution to Problem

The present inventors found that configuration examples below can solve the above problem, completing the present invention.

The configuration examples of the present invention are as described below.

[1] A press-bonded body of at least one of a base material selected from the group consisting of non-woven fabric, stretched porous film, and fiber,

in which the base material comprises a fluorine resin (except for polytetrafluoroethylene) having a —CF₂— group content of 85% by mass or greater, and

in which polytetrafluoroethylene fibrils bond fibers constituting the base material, and in relation to the entirety of the fibrils, the proportion of the number of fibrils that are oriented at an angle of 45° to 90° relative to the direction of the fibers constituting the base material is 50% or greater.

[2] The press-bonded body described in [1], in which the polytetrafluoroethylene content is from 0.2% to 12% by mass relative to 100% by mass of the base material.

[3] The press-bonded body described in [1] or [2], in which the average fiber diameter of the fibrils is from 10 nm to 1 μm.

[4] The press-bonded body described in any one of [1] to [3], in which the base material comprises at least one of a fluorine resin selected from the group consisting of a tetrafluoroethylene-perfluoroalkyl vinyl ether copolymer (PFA), a tetrafluoroethylene-hexafluoropropylene copolymer (FEP), an ethylene-tetrafluoroethylene copolymer (ETFE), a tetrafluoroethylene-hexafluoropropylene-perfluoroalkyl vinyl ether copolymer (EPE), a fluoroethylene-vinyl ether copolymer (FEVE), and a poly(chlorotrifluoroethylene) (PCTFE).

[5] A method for producing a press-bonded body, comprising a step 1 of

press-bonding at least one of a base material selected from the group consisting of non-woven fabric, stretched porous film, and fiber

in the presence of polytetrafluoroethylene particles, and

carbon dioxide in a liquid state, a gas-liquid mixture state, or a nearly liquid state.

[6] The method for producing a press-bonded body described in [5], in which the step 1 is

a step 1a in which at least one of a base material selected from the group consisting of non-woven fabric, stretched porous film, and fiber, and a polytetrafluoroethylene dispersion are brought into contact with liquid or gaseous carbon dioxide, and is pressurized, or

a step 1b in which at least one selected from the group consisting of non-woven fabric, stretched porous film, and fiber is brought into contact with a polytetrafluoroethylene dispersion, and is subsequently dried to obtain a dried body, and the dried body is brought into contact with liquid or gaseous carbon dioxide and is pressurized.

[7] The method for producing a press-bonded body described in [5] or [6], in which the press-bonded body has a structure such that polytetrafluoroethylene fibrils bond the base material.

[8] The method for producing a press-bonded body described in [7], in which the proportion of the number of fibrils that are oriented at an angle of 0° to 45° relative to the press-bonding direction is 50% or greater in relation to the entirety of the fibrils.

[9] The method for producing a press-bonded body described in any one of [5] to [8], in which the polytetrafluoroethylene content in the press-bonded body is 0.2% to 12% by mass in relation to 100% by mass of the base material in the press-bonded body.

[10] The method for producing a press-bonded body described in [7] or [8], in which the average fiber diameter of the fibrils is from 10 nm to 1 μm.

[11] The method for producing a press-bonded body described in any one of [5] to [10], in which the base material comprises at least one of a fluorine resin selected from the group consisting of a tetrafluoroethylene-perfluoroalkyl vinyl ether copolymer (PFA), a tetrafluoroethylene-hexafluoropropylene copolymer (FEP), an ethylene-tetrafluoroethylene copolymer (ETFE), a tetrafluoroethylene-hexafluoropropylene-perfluoroalkyl vinyl ether copolymer (EPE), a fluoroethylene-vinyl ether copolymer (FEVE), and a poly(chlorotrifluoroethylene) (PCTFE).

### Advantageous Effects

According to some non-limiting embodiments or aspects, a press-bonded body in an intended shape, exhibiting excellent mechanical strength and having, for example, fibers which hardly fray and base materials which hardly peel off from each other is obtainable.

### BRIEF DESCRIPTION OF DRAWINGS

FIG. 1 is a SEM image between PFA fibers in a press-bonded body of Example 2.

FIG. 2 is a SEM image between PFA fibers in a press-bonded body of Comparative Example 2.

FIG. 3 is a SEM image between PFA fibers in a press-bonded body of Example 1.

FIG. 4 is a SEM image between PFA fibers in a press-bonded body of Comparative Example 1.

FIG. 5 is a SEM image of a cross section of a press-bonded body of Comparative Example 5.

FIG. 6 is a photograph of the appearance of a press-bonded body of Example 2.

FIG. 7 is a photograph of the appearance of a press-bonded body of Comparative Example 2.

### DESCRIPTION OF EMBODIMENTS

<<Press-Bonded Body>>

The press-bonded body according to an embodiment (this may be hereinafter referred to as “present press-bonded body”) is characterized in that:

the press-bonded body is a press-bonded body of at least one of a base material selected from the group consisting of non-woven fabric, stretched porous film, and fiber (this fiber may be hereinafter referred to as “fiber A”);

the base material comprises a fluorine resin (except for polytetrafluoroethylene (PTFE)) having a —CF₂— group content of 85% by mass or greater; and

polytetrafluoroethylene fibrils bond fibers constituting the base material, and in relation to the entirety of the fibrils, the proportion of the number of fibrils that are oriented at an angle of 45° to 90° relative to the direction of the fibers constituting the base material is 50% or greater.

When a non-woven fabric is used as the base material, examples of the present press-bonded bodies are a press-bonded body of a single sheet of a non-woven fabric; a press-bonded body using 2 or more sheets of one or more types of non-woven fabrics, which are press-bonded to each other; and a press-bonded body of one or more types of non-woven fabrics and at least one selected from the group consisting of stretched porous film and fiber(s) A, which are press-bonded to each other.

The above press-bonded body of a single sheet of a non-woven fabric is such that voids in the non-woven fabric are reduced. Even in this case, however, a press-bonded body having a reduced volume while maintaining voids, not a simple film formed as a result of the complete elimination of voids from the non-woven fabric, is obtainable according to an embodiment, particularly by the present method below.

Examples of a press-bonded body in which stretched porous film or fiber(s) A is(are) used as the base material are also the same as the above example in which non-woven fabric is used. When a single type of a fiber A is used as the base material, a press-bonded body is obtainable by bonding a single folded fiber A with PTFE fibrils; however, 2 or more fibers A are ordinarily used.

From the viewpoint for example that the effects of the present invention are more exhibited, press-bonded bodies of 2 or more sheets of a non-woven fabric are preferred among the above. The press-bonding of 2 or more sheets of the fluorine resin-containing non-woven fabric has conventionally been not easy, or it has been performable by fusion accompanied by the elimination of voids contained in the non-woven fabric. According to some non-limiting embodiments or aspects, particularly by the present method below, 2 or more sheets of the non-woven fabric can be press-bonded to each other while maintaining voids in the non-woven fabric (in a fluffy state).

The description “PTFE fibrils bond fibers constituting the base material” means, for example, when a non-woven fabric is used as the base material, fibers constituting the non-woven fabric; fibers constituting the non-woven fabric and fibers constituting a stretched porous film; or fibers constituting the non-woven fabric and fiber(s) A are bonded (crosslinked or linked) with PTFE fibrils. In this case, PTFE fibrils ordinarily bond adjacent fibers among the fibers constituting the base material.

The same also applies when a stretched porous film or fiber(s) A are used as the base material.

In addition, the description “in relation to the entirety of the fibrils, the proportion of the number of fibrils that are oriented at an angle of 45° to 90° relative to the direction of the fibers constituting the base material is 50% or greater” means that, in relation to the entirety of the fibrils constituting the press-bonded body, the proportion of the number of fibrils that are oriented in a nearly vertical direction relative to the direction of the fibers constituting the base material is 50% or greater. The angle of 45° means the same as the angle of 135° when the direction of angle measurement is changed. That is, the angle of 45° to 90° means the same as the angle of 90° to 135°.

Due to a large number of PTFE fibrils that are oriented in a nearly vertical direction relative to the direction of the fibers constituting a base material, the present press-bonded body has an intended shape, exhibits excellent mechanical strength, and has fibers which hardly fray and base materials which hardly peel off from each other for example.

The number of fibrils that are oriented at an angle of 45° to 90° relative to the direction of the fibers constituting the base material is preferably the number of fibrils that are oriented at an angle of 70° to 90° relative to the direction of the fibers constituting the base material, and more preferably the number of fibrils that are oriented at an angle of 80° to 90° relative to the direction of the fibers constituting the base material.

In relation to the entirety of the fibrils constituting a press-bonded body, the proportion of the number of fibrils that are oriented in a nearly vertical direction relative to the direction of the fibers constituting the base material is preferably 75% to 100%, and more preferably 85% to 100% from the viewpoint for example that the press-bonded body can more advantageously exhibit the above effects.

The orientation direction of the fibrils can be determined by confirming the orientation direction of any 40 fibrils relative to the direction of fibers constituting a base material in a SEM image of a cross section of a press-bonded body. The proportion is a value calculated from the number of fibrils that are oriented in a nearly vertical direction relative to the direction of the fibers constituting the base material, in relation to the 40 fibrils.

The shape and size of the present press-bonded body are not particularly limited and may be appropriately selected depending on intended applications for example.

The thickness of the present press-bonded body is also not particularly limited and may be appropriately selected depending on applications. In cases of press-bonded bodies of non-woven fabric or stretched porous film, the thickness is ordinarily 10 μm or greater, preferably 50 μm or greater, and ordinarily 30 mm or less, preferably 25 mm or less.

The present press-bonded body may be appropriately used for applications in which fluorine resin-containing non-woven fabric, stretched porous film, or fiber(s) A have been used, particularly in the fields such as medical treatment, electrical equipment, and semiconductors, and specifically as filters, various types of separators, and clothes for example.

In accordance with intended applications, the present press-bonded body may contain one or more types of functional materials required for the applications. Specific examples of the functional materials are food materials, chemicals (for medicine, agriculture, and industries), pigments, adsorbents, deodorants, aromatics, insecticides, electronic device materials, enzymes, and catalysts.

The present press-bonded bodies, when containing the functional materials as such, particularly containing the functional materials being inferior in heat resistance, enable the obtainment of press-bonded bodies that make the best use of, for example, the functions and properties of the functional materials.

For example, when containing materials such as chemicals, press-bonded bodies having properties such as the controlled sustained release of the chemicals are obtainable.

<Base Material>

The base material comprises a fluorine resin (except for PTFE) having a —CF₂— group content of 85% by mass or greater, and a base material consisting of the fluorine resin is preferred.

The —CF₂— group content in a fluorine resin can be measured and calculated by methods such as solid nuclear magnetic resonance (NMR) or mass spectrometry (MS spectrometry).

The fluorine resin is not particularly limited as long as it has a —CF₂— group content of 85% by mass or greater in the composition of the resin and is not PTFE. Specific examples thereof are a tetrafluoroethylene-perfluoroalkyl vinyl ether copolymer (PFA), a tetrafluoroethylene-hexafluoropropylene copolymer (FEP), an ethylene-tetrafluoroethylene copolymer (ETFE), a tetrafluoroethylene-hexafluoropropylene-perfluoroalkyl vinyl ether copolymer (EPE), a fluoroethylene-vinyl ether copolymer (FEVE), and a poly(chlorotrifluoroethylene) (PCTFE).

The base material may comprise 2 or more types of fluorine resins, but ordinarily comprises a single type of a fluorine resin.

Among the above fluorine resins, PFA and FEP are preferred in terms of excellent mechanical strength, heat resistance, chemical resistance, weatherability, and electrical isolation properties for example, and PFA is more preferred since it is prone to plasticization for example, by carbon dioxide in the present method below.

Since PFA is non-adhesive and has a low coefficient of friction, a press-bonded body of at least one selected from PFA non-woven fabric, PFA stretched porous film, and PFA fiber(s) A, having excellent mechanical strength has not been conventionally obtainable. According to some non-limiting embodiments or aspects, a press-bonded body in an intended shape, exhibiting excellent mechanical strength and having fibers which hardly fray and base materials which hardly peel off from each other for example, is easily obtainable even though it comprises PFA as such.

The non-woven fabric, stretched porous film, and fiber A are not particularly limited, and conventionally known non-woven fabric, stretched porous film, and fiber A may be used.

The average fiber diameter of fibers constituting the non-woven fabric or the fiber A is preferably 0.1 μm or greater, more preferably 5 μm or greater, and still more preferably 10 μm or greater; and preferably 200 μm or less, more preferably 100 μm or less, and still more preferably 80 μm or less.

The average fiber diameter within the above range is preferred from the viewpoint for example that a greater number of PTFE fibrils can be formed due to the enlarged fiber surface area, enabling the obtainment of a press-bonded body in an intended shape, exhibiting excellent mechanical strength and having fibers which hardly fray and base materials which hardly peel off from each other for example.

The average fiber diameter is an average value calculated based on the results of measurement in which fibers (or a fiber group) to be measured are observed with a scanning electron microscope (SEM), 20 fibers are randomly selected from an obtained SEM image, and the fiber diameter (major axis) of each fiber is measured.

With respect to fibers constituting the non-woven fabric and the fiber A, the coefficient of variation of fiber diameter calculated by the formula below is preferably 0.7 or less, more preferably 0.01 or greater and more preferably 0.5 or less. When the coefficient of variation of fiber diameter is within the above range, uniform fiber diameters are achievable, enabling the easy obtainment of a press-bonded body in an intended shape, exhibiting excellent mechanical strength and having fibers which hardly fray and base materials which hardly peel off from each other for example.

Coefficient of variation of fiber diameter=standard deviation/average fiber diameter

(“Standard deviation” is a standard deviation of the fiber diameters of the above 20 fibers.)

With respect to fibers constituting the non-woven fabric and the fiber A, fiber length is not particularly limited and is preferably 0.5 mm or greater, more preferably 1 mm or greater; and preferably 100 mm or less, more preferably 50 mm or less.

The stretched porous film is not particularly limited and may be a uniaxially stretched porous film or a biaxially stretched porous film.

The percentage of voids or porosity of the non-woven fabric or stretched porous film is not particularly limited and is 0.1% by volume or greater, preferably 1% by volume or greater; and 70% by volume or less, preferably 60% by volume or less, for example.

The percentage of voids or porosity is calculatable by the formula below from the difference between a theoretical volume and an actual volume. The theoretical volume is calculated from a specific gravity of a resin constituting a non-woven fabric or a stretched porous film, and an actual mass of the non-woven fabric or the stretched porous film, on the assumption that voids or pores are not present therein. The actual volume is calculated by measuring the dimension of the non-woven fabric or the stretched porous film.

Percentage of voids or porosity (% by volume)=(1−(theoretical volume/actual volume))×100

The basis weight of the non-woven fabric or the stretched porous film is preferably 100 g/m² or less, more preferably 1 g/m² or greater, and more preferably 80 g/m² or less.

The thickness of the non-woven fabric or the stretched porous film is ordinarily 10 μm or greater, preferably 50 μm or greater; and ordinarily 1 mm or less, preferably 500 μm or less.

<PTFE Fibrils>

In the present press-bonded body, PTFE fibrils bond fibers constituting the base material.

The PTFE fibrils are preferably formed from PTFE particles (particles contained in a PTFE dispersion), and ordinarily have no node. Namely, fibrils contained in the present press-bonded body differ from fibrils formed by stretching.

The average fiber diameter of the fibrils is preferably 10 nm or greater, more preferably 50 nm or greater, particularly preferably 80 nm or greater; and preferably 1 μm or less, more preferably 800 nm or less, and particularly preferably 500 nm or less, from the viewpoint for example that base materials can be tightly bonded, and thereby a press-bonded body in an intended shape, exhibiting excellent mechanical strength and having, for example, fibers which hardly fray and base materials which hardly peel off from each other is easily obtainable.

The average fiber diameter of the fibrils is calculatable as with the calculation of the average fiber diameter of the fibers.

The average fiber length of the fibrils is not particularly limited, and any length is acceptable as long as the fibrils can bond (adjacent) fibers constituting a base material in an obtained press-bonded body, and is ordinarily 1 μm or greater, preferably 10 μm or greater; and ordinarily 100 μm or less, preferably 40 μm or less.

The average fiber length is an average value calculated based on the results of the measurement in which fibrils (or a fibril group) to be measured are observed with a scanning electron microscope (SEM), 20 fibrils are randomly selected from an obtained SEM image, and the fiber length of each fibril is measured.

In the present press-bonded body, the content of the fibrils (PTFE content) relative to 100% by mass of the base material is preferably 0.2% by mass or greater, more preferably 1% by mass or greater, particularly preferably 2% by mass or greater; and preferably 12% by mass or less, more preferably 10% by mass or less, particularly preferably 5% by mass or less, from the viewpoint for example that base materials can be tightly bonded, and thereby a press-bonded body in an intended shape, exhibiting excellent mechanical strength and having, for example, fibers which hardly fray and base materials which hardly peel off from each other is easily obtainable.

<Method for Producing Press-Bonded Body>

The method for producing a press-bonded body according to some embodiments (this may also be referred to as “the present method”) comprises

a step 1 of press-bonding at least one of a base material selected from the group consisting of non-woven fabric, stretched porous film, and fiber A

in the presence of PTFE particles, and

carbon dioxide in a liquid state, a gas-liquid mixture state, or a nearly liquid state.

The base material preferably comprises a fluorine resin (except for polytetrafluoroethylene) having a —CF₂— group content of 85% by mass or greater. In this case, the present method can also be regarded as a novel method for processing at least one selected from fluorine resin-containing non-woven fabric, stretched porous film, and fiber A, which are difficult to process.

According to the present method as such, a press-bonded body is producible at a temperature of approximately 50° C. or lower in a short time at low cost, without applying a high temperature at which a resin constituting a base material is melted. In addition, since the obtained press-bonded body basically does not retain carbon dioxide, a clean press-bonded body excelling in safety, controllability, and productivity is easily obtainable, and a press-bonded body in an intended shape, exhibiting excellent mechanical strength and having fibers which hardly fray and base materials which hardly peel off from each other for example, is easily obtainable. Particularly, a press-bonded body is obtainable while making the best use of the properties of a base material (e.g., voids and fiber shape in non-woven fabric).

Moreover, according to the present method, during the production of a press-bonded body comprising the functional materials used in accordance with intended applications, a press-bonded body that makes the best use of the functions and properties of the functional materials for example, is obtainable even though the functional materials have inferior heat resistance.

The present press-bonded body is preferably a press-bonded body obtained by the present method. According to the present method, a press-bonded body in which PTFE fibrils bond fibers constituting a base material is easily obtainable.

In this case, a preferred press-bonded body obtained by the present method is such that the proportion of the number of fibrils that are oriented at an angle of 0° to 45° relative to the press-bonding direction is 50% or greater in relation to the entirety of the fibrils, from the viewpoint for example that base materials can be tightly bonded, enabling the easy obtainment of a press-bonded body in an intended shape, exhibiting excellent mechanical strength and having, for example, fibers which hardly fray and base materials which hardly peel off from each other.

With respect to press-bonded bodies produced by the present method, fibers constituting a base material tend to be oriented in a nearly vertical direction relative to a press-bonding direction, and PTFE fibrils tend to be oriented nearly in a press-bonding direction so as to link the fibers. Thus, “the proportion of the number of fibrils that are oriented at an angle of 0° to 45° relative to the press-bonding direction is 50% or greater in relation to the entirety of the fibrils” corresponds to “the proportion of the number of fibrils that are oriented at an angle of 45° to 90° relative to the direction of fibers constituting the base material is 50% or greater in relation to the entirety of the fibrils” in the present press-bonded body.

The description “the proportion of the number of fibrils that are oriented at an angle of 0° to 45° relative to the press-bonding direction is 50% or greater in relation to the entirety of the fibrils” means that the proportion of the number of fibrils that are oriented in a nearly parallel direction relative to the press-bonding direction (namely a direction in which pressure is applied) is 50% or greater in relation to the entirety of fibrils constituting a press-bonded body.

As with the above, the angle of 45° means the same as the angle of 315° when the direction of angle measurement is changed. That is, the angle of 0° to 45° means the same as the angle of 315° to 360°.

The number of fibrils that are oriented at an angle of 0° to 45° relative to the press-bonding direction is preferably the number of fibrils that are oriented at an angle of 0° to 20° relative to the press-bonding direction, and more preferably the number of fibrils that are oriented at an angle of 0° to 10° relative to the press-bonding direction.

The proportion of the number of the fibrils that are oriented in a nearly parallel direction relative to the press-bonding direction is preferably 75% to 100% and more preferably 85% to 100% in relation to the entirety of fibrils constituting a press-bonded body, from the viewpoint for example that a press-bonded body in an intended shape, exhibiting more excellent mechanical strength and having, for example, fibers which further hardly fray and base materials which further hardly peel off from each other is easily obtainable.

The orientation direction of the fibrils can be determined by confirming the orientation direction of any 40 fibrils relative to the press-bonding direction in a SEM image of a cross section of the press-bonded body, and the proportion is a value calculated from the number of fibrils that are oriented in a nearly parallel direction relative to the press-bonding direction, in relation to the 40 fibrils.

A reason why a press-bonded body in an intended shape, exhibiting excellent mechanical strength and having fibers which hardly fray and base materials which hardly peel off from each other for example, is obtainable by the present method is not necessarily clarified. However, it is supposed that when pressure is applied in the presence of carbon dioxide in a liquid state, a gas-liquid mixture state, or a nearly liquid state, surfaces of base materials are plasticized due to the carbon dioxide, and by applying pressure in a plasticized state, the base materials can be bonded and linked by fixing the shape in a state in which the base materials are engaged.

<Step 1>

The step 1 is not particularly limited as long as it is a step of press-bonding a base material in the presence of PTFE particles and carbon dioxide in a liquid state, a gas-liquid mixture state, or a near liquid state, and one or more functional materials required for the application may be contained during the press-bonding in accordance with an intended application. Examples of the functional materials are the same as those described in <<Press-bonded body>> above.

Even though the functional materials have inferior heat resistance, the present method enables the obtainment of press-bonded bodies that make the best use of the functions and properties of the functional materials for example.

PTFE particles used in the step 1 are not particularly limited, and conventionally known PTFE particles may be used. Two or more types of PTFE particles having different average particle diameters for example, may also be used.

In the step 1, a PTFE dispersion is preferably used from the viewpoints for example that intended press-bonded bodies are easily formable. In this case, it is sufficient that PTFE particles are present during the press-bonding of base materials. Thus, a contact body obtained by bringing a base material with a PTFE dispersion may be press-bonded in contact with carbon dioxide, or otherwise a dried body previously obtained by bringing a base material into contact with a PTFE dispersion and thereafter drying the base material, may be press-bonded in contact with carbon dioxide.

The average particle diameter of the PTFE particles is preferably 0.15 μm to 0.35 μm, from the viewpoint for example that base materials can be more tightly bonded and a press-bonded body in an intended shape, exhibiting excellent mechanical strength and having, for example, fibers which hardly fray and base materials which hardly peel off from each other is easily obtainable.

The average particle diameter is measurable by a light-scattering method.

The PTFE dispersion is not particularly limited, and a conventionally known dispersion may be used. From the viewpoint for example that an intended press-bonded body is easily formable, a dispersion having a PTFE particle concentration of 10% to 60% by mass is preferably used.

The PTFE dispersion may contain conventionally known additives such as a stabilizer.

The amount of the PTFE particles used in relation to 100% by mass of a base material used in the step 1 is preferably 0.2% by mass or greater, more preferably 1% by mass or greater, particularly preferably 2% by mass or greater; and preferably 12% by mass or less, more preferably 10% by mass or less, particularly preferably 5% by mass or less, from the viewpoint for example that base materials can be tightly bonded, enabling the easy obtainment of a press-bonded body in an intended shape, exhibiting excellent mechanical strength and having fibers which hardly fray and base materials which hardly peel off from each other for example.

In the step 1, a base material is press-bonded in the presence of carbon dioxide in a liquid state, a gas-liquid mixture state, or a nearly liquid state. It is supposed that when carbon dioxide in a liquid state, a gas-liquid mixture state, or a nearly liquid state is brought into contact with a base material, the base material is impregnated with carbon dioxide and is plasticized, enabling the production of a press-bonded body without heating.

In the step 1, carbon dioxide in a subcritical state or a supercritical state may be used, but carbon dioxide in a liquid state or a gas-liquid mixture state is preferred from the viewpoint for example that press force is reducible and press-bonding is performable without a device having systems such as a heating system. Moreover, carbon dioxide in a gas state is supposed to barely plasticize a base material or to take a very long time to plasticize the same. Thus, carbon dioxide in a liquid state or a gas-liquid mixture state is preferred from the viewpoint for example that a base material appears to be immediately plasticizable.

The “carbon dioxide in a nearly liquid state” is specifically carbon dioxide in a state in which the density is 0.4 g/mL (approximately half the density of carbon dioxide in a liquid state) or greater.

Specifically, the step 1 is preferably performed by introducing liquid or gaseous carbon dioxide into a system. That is, specifically, the following step 1a or 1b is preferred as the step 1.

Step 1a: a step in which at least one of a base material selected from the group consisting of non-woven fabric, stretched porous film, and fiber A and a polytetrafluoroethylene dispersion are brought into contact with liquid or gaseous carbon dioxide, and is pressurized.

Step 1b: a step in which at least one of a base material selected from the group consisting of non-woven fabric, stretched porous film, and fiber A is brought into contact with a polytetrafluoroethylene dispersion, and is subsequently dried to obtain a dried body, and the dried body is brought into contact with liquid or gaseous carbon dioxide and is pressurized.

During the introduction of liquid or gaseous carbon dioxide into a system, the introduction order of a base material, PTFE particles and carbon dioxide into the system is not particularly limited. For example, a base material and PTFE particles may be introduced into a system charged with carbon dioxide, but it is preferred that carbon dioxide is introduced into a system into which a base material and PTFE particles have been introduced.

When liquid carbon dioxide is introduced, a compression step for liquefaction is omittable, enabling the production of a press-bonded body taking a short amount of time, compared with the case in which gaseous carbon dioxide is introduced.

In contrast, when gaseous carbon dioxide is introduced, the process is easy and the device can be simplified by omitting a press pump, compared with the case in which liquid carbon dioxide is introduced. When gaseous carbon dioxide is introduced, carbon dioxide is ordinarily liquified by pressurizing the introduced carbon dioxide. In this case, it is sufficient that at least a part of the introduced carbon dioxide, not the entirety thereof, is liquified.

The amount of carbon dioxide to be introduced is not particularly limited. When gaseous carbon dioxide is introduced and press-bonding is performed at a temperature of 31° C. (i.e., critical temperature of carbon dioxide) or higher, carbon dioxide is introduced such that the carbon dioxide density during the press-bonding is 0.4 g/mL (half the density of liquid carbon dioxide) or greater.

During the press-bonding in the step 1, surface pressure may be appropriately selected in accordance with the type and amount of a base material to be used and the intended shape of a press-bonded body for example. The surface pressure is preferably 4 MPa or greater, and more preferably 5 MPa or greater. The upper limit is not particularly limited and is 50 MPa or lower, for example.

The surface pressure is a sum of the pressure of carbon dioxide introduced into the system and the press pressure.

During the press-bonding in the step 1, the press duration may be appropriately selected in accordance with, for example, the type and amount of a base material to be used and surface pressure and temperature during the press-bonding, and is preferably 0.2 seconds or longer, more preferably a second or longer; and preferably 15 minutes or shorter, more preferably 5 minutes or shorter.

In the step 1, a temperature at which the press-bonding is performed may be appropriately selected in accordance with the type and amount of a base material to be used and the intended shape of a press-bonded body for example. By the present method, intended press-bonded bodies are obtainable without applying temperature. Thus, from the viewpoint for example that the effect as such is more remarkably exhibited, the temperature at which the press-bonding is performed is ordinarily 0° C. or higher, more preferably 20° C. or higher; and ordinarily 40° C. or lower, more preferably 30° C. or lower.

The step 1 may be performed in a hermetic container whose volume is reducible or may also be performed using an open system press device.

An example of the hermetic container is a container having an introduction unit for introducing liquid or gaseous carbon dioxide into the hermetic container, a exhaust unit for exhausting carbon dioxide, and a component such as a piston which can reduce the volume of the hermetic container to press a base material.

An example of a method using an open system press device is such that a contact body obtained by bringing the base material into contact with a PTFE dispersion, or a dried body thereof is placed between press components such as pistons and is pressed while introducing thereto liquid carbon dioxide.

When an open system press device is used, an object base material can be processed in spots without using a large processing container covering the entirety of the object base material. For example, a base material is repeatedly pressed by feeding the base material which changes the position to be pressed. Further a press-bonded body is continuously producible by a method in which a base material is pressed using rollers instead of pistons.

### EXAMPLES

Next, the present invention is described in further detail below with reference to, but not limited to, examples.

### Example 1

Into a hermetically-closable container (caliber: φ 20 mm) having a piston, a carbon dioxide introduction unit, and a carbon dioxide exhaust unit, 0.5 g of PFA short fibers with an average fiber diameter of 60 μm, and 0.03 g of a PTFE dispersion (POLYFLON PTFE-D D-210C, produced by DAIKIN INDUSTRIES, Ltd., aqueous dispersion having solids of 60% by mass, average particle diameter of PTFE particles: 0.22 μm) (proportion of PTFE mass relative to PFA mass: 3.6% by mass) were fed. Carbon dioxide equivalent to carbon dioxide under the vapor pressure thereof (cylinder pressure: 6 MPa) was introduced thereinto at room temperature (25° C.), the volume in the container was reduced by pushing the piston (while liquifying carbon dioxide) to apply a pressure with a load of 100 N (surface pressure: 6.3 MPa) for 10 seconds in order to press-bond the PFA fibers to one another. Thereafter carbon dioxide was instantly exhausted while maintaining the pressure, the pressure was subsequently relieved, and then a press-bonded body (φ 20 mm) was removed from the container.

### Example 2

A press-bonded body was prepared in the same manner as described in Example 1 except for changing the pressure during the press-bonding to a load of 3000 N (surface pressure: 18 MPa).

### Example 3

A press-bonded body was prepared in the same manner as described in Example 1 except for changing the pressure during the press-bonding to a load of 5000 N (surface pressure: 22 MPa).

### Comparative Example 1

A press-bonded body was prepared in the same manner as described in Example 1 except for introducing no carbon dioxide.

### Comparative Example 2

A press-bonded body was prepared in the same manner as described in Example 2 except for introducing no carbon dioxide.

### Comparative Example 3

A press-bonded body was prepared in the same manner as described in Example 3 except for introducing no carbon dioxide.

### Comparative Example 4

Using a hand press (Mini Test Press MP-WCH, produced by Toyo Seiki Seisakusho, Ltd.), 0.5 g of PFA short fibers having an average fiber diameter of 60 μm were pressed under the conditions of a temperature of 260° C. and a surface pressure of 12 MPa for 5 minutes to prepare a press-bonded body (thickness: 1.5 mm).

### Comparative Example 5

A press-bonded body (thickness: 1.0 mm) was prepared in the same manner as described in Comparative Example 4 except for changing the temperature to 320° C.

The press-bonded bodies obtained in the examples and comparative examples were evaluated as described below.

1. Structure Observation

The structures between the PFA fibers were observed using a SEM (S-3400N, produced by K.K. Hitachi High Technologies) with a 500-fold or 1000-fold magnification, and points such as the presence of PTFE fibrils and the orientation of the PTFE fibrils were confirmed.

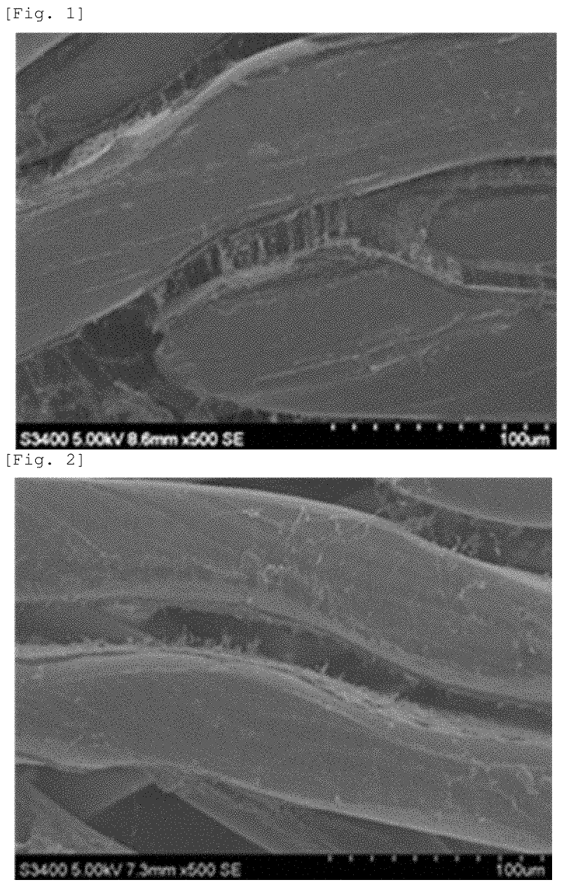

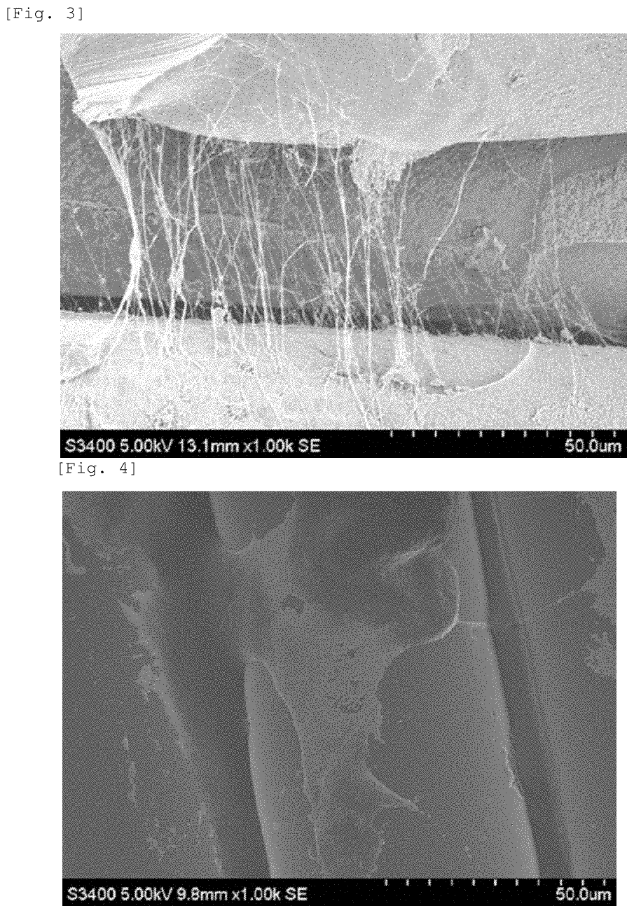

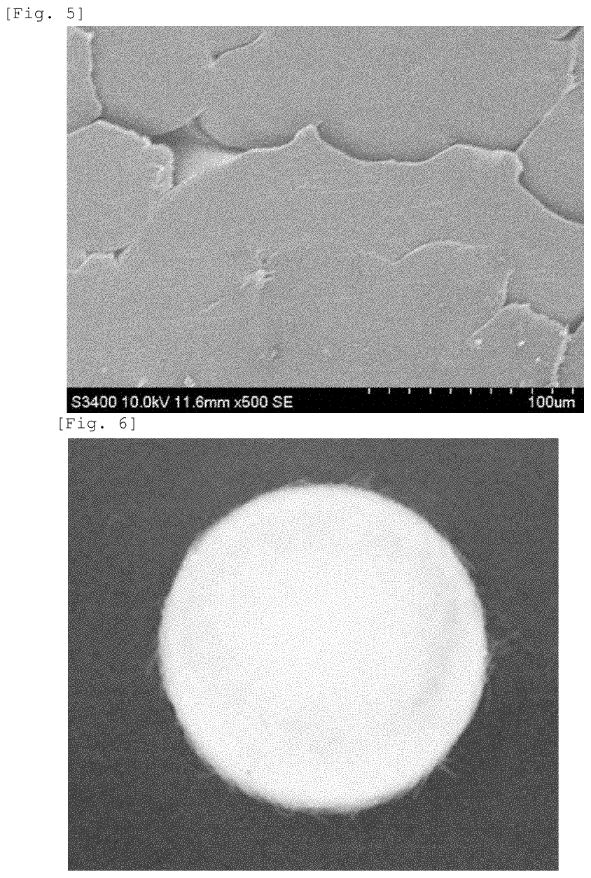

As typical examples of the SEM images of the press-bonded bodies of Examples 1 to 3 and Comparative Examples 1 to 4, the SEM images of the press-bonded bodies of Example 2 and Comparative Example 2 taken with a 500-fold magnification are shown in FIGS. 1 and 2, respectively, and the SEM images of the press-bonded bodies of Example 1 and Comparative Example 1 taken with a 1000-fold magnification are shown in FIGS. 3 and 4, respectively.

Based on the obtained SEM images, an average fiber diameter of PTFE fibrils was measured. The average fiber diameter is an average value calculated based on the results of measurement in which 20 fibers were randomly selected from the obtained SEM image, and the fiber diameter of each fibril was measured. The results are summarized in Table 1.

In addition, from the obtained SEM image, 40 fibrils were randomly selected, the angle of each fibril relative to the PFA fiber direction was measured, and the proportion of the number of fibrils that were oriented at an angle of 45° to 90° relative to the PFA fiber direction (the proportion of fibrils in a nearly vertical direction relative to the base material fibers) in relation to the 40 fibrils was calculated. The results are summarized in Table 1.

With respect to the press-bonded bodies obtained in Examples 1 to 3, PTFE fibrils bonded adjacent PFA fibers in a nearly vertical direction relative to the fiber direction, and thereby PFA fibers were integrated with each other. Specifically, in the press-bonded body obtained in Example 1, PTFE fibrils having a fiber diameter of approximately several tens of nm (minimum fiber diameter: 40 nm, average fiber diameter: 80 nm) bonded PFA fibers so as to link the PFA fibers. In Examples 2 and 3, fibrils having a fiber diameter of approximately 0.2 to 0.3 μm were also formed. In the press-bonded bodies obtained in Examples 1 to 3, the numbers of fibrils that were oriented relative to the PFA fiber direction at an angle of 45° to 90° and at an angle of 80° to 90° were nearly the same.

In contrast, in the press-bonded bodies obtained in Comparative Examples 1 to 4, it was not observed that PTFE fibrils bonded PFA fibers so as to link the PFA fibers, and it was confirmed as shown in FIG. 4 that PTFE dispersion-derived PTFE primary particles having an average particle diameter of approximately 0.2 μm were deposited on PFA fibers or in gaps between the fibers.

Using a SEM similar to the above described one, the structure of a cross section of the press-bonded body obtained in Comparative Example 5 was observed with a 500-fold magnification. The SEM image is shown in FIG. 5.

The press-bonded body obtained in Comparative Example 5 was a press-bonded body (film) that was changed into a film in which voids were eliminated due to thermally fused fibers, and the significance of using fibers could not be found.

2. Thickness Measurement

The thickness of the prepared press-bonded bodies was measured with a micrometer (LITEMATIC VL-50, produced by Mitutoyo Corporation). The results are summarized in Table 1.

3. Maximum Piercing Resistance Measurement

With respect to the mechanical properties of the prepared press-bonded bodies, a piercing test was performed using a universal tensile tester (EZ-test, produced by Shimadzu Corporation).

Specifically, the press-bonded body with φ 20 mm was attached onto a dedicated jig having a hole with φ 12 mm, and a maximum piercing resistance, when the press-bonded body was pierced with a piercing needle having φ 1 mm and a tip R of 0.5 mm at a rate of 1 mm/s, was obtained. The results are summarized in Table 1.

TABLE 1

| | | | | Comparative | | |
|---|---|---|---|---|---|---|
| | Examples | | | Examples | | |
| | 1 | 2 | 3 | 1 | 2 | 3 |
| Average fiber diameter | 80 | 185 | 190 | — | — | — |
| of fibrils (nm) | | | | | | |
| Thickness (mm) | 2.4 | 1.3 | 1.2 | 5.5 | 1.4 | 1.4 |
| Proportion of number | 90 | 95 | 95 | — | — | — |
| of fibrils oriented at | | | | | | |
| an angle of 45° to 90° | | | | | | |
| relative to base material | | | | | | |
| fiber direction (%) | | | | | | |
| Maximum piercing | — | 5.79 | 8.96 | — | 3.18 | 3.51 |
| resistance (N) | | | | | | |

The press-bonded bodies obtained in the examples had increased resistance when being pierced since adjacent PFA fibers were integrated with PTFE fibrils. Thus, according to some embodiments, strong press-bonded bodies having excellent mechanical strength could be easily obtained.

4. Measurement of Thermal Dimensional Change in Press-Bonded Body

With respect to the prepared press-bonded bodies, the thickness of the press-bonded bodies before and after heating in an electric furnace at a temperature of 260° C. for an hour was measured in the same manner as described in the above 2, in order to confirm the extent of thermal peeling between fibers. The results are summarized in Table 2.

TABLE 2

| | Example 2 | Comparative Example 2 |
|---|---|---|
| Thickness before heating (mm) | 1.3 | 1.4 |
| Thickness after heating (mm) | 2.8 | 3.9 |

With respect to the press-bonded bodies obtained in the examples, it is assumed that the peeling of PFA fibers due to thermal expansion was suppressed since adjacent PFA fibers were integrated with each other with PTFE fibrils, even when the press-bonded bodies were heated at 260° C.

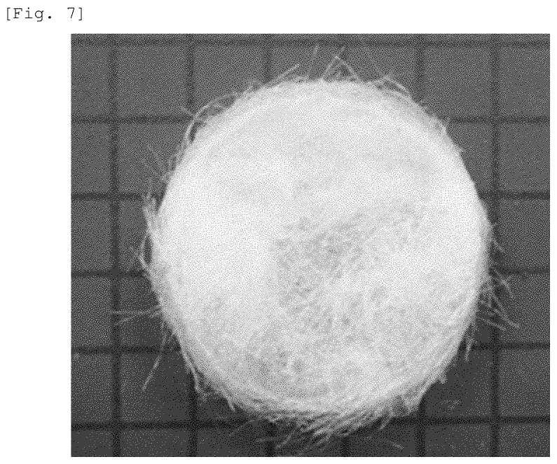

As typical examples of the press-bonded bodies of Examples 1 to 3 and Comparative Examples 1 to 4, the appearance photographs of the press-bonded bodies themselves of Example 2 and Comparative Example 2 are shown in FIGS. 6 and 7, respectively. The figures show that press-bonded bodies in an intended shape, in which the fraying of the fibers for example was suppressed, were obtained in the examples.

1. A press-bonded body of at least one of a base material selected from the group consisting of non-woven fabric, stretched porous film, and fiber,
in which the base material comprises a fluorine resin, except for polytetrafluoroethylene, having a —CF₂— group content of 85% by mass or greater, and
in which polytetrafluoroethylene fibrils bond fibers constituting the base material, and in relation to the entirety of the fibrils, the proportion of the number of fibrils that are oriented at an angle of 45° to 90° relative to the direction of the fibers constituting the base material is 50% or greater.

2. The press-bonded body according to claim 1, in which the polytetrafluoroethylene content is from 0.2% to 12% by mass relative to 100% by mass of the base material.

3. The press-bonded body according to claim 1, in which the average fiber diameter of the fibrils is from 10 nm to 1 μm.

4. The press-bonded body according to claim 1, in which the base material comprises at least one of a fluorine resin selected from the group consisting of a tetrafluoroethylene-perfluoroalkyl vinyl ether copolymer, a tetrafluoroethylene-hexafluoropropylene copolymer, an ethylene-tetrafluoroethylene copolymer, a tetrafluoroethylene-hexafluoropropylene-perfluoroalkyl vinyl ether copolymer, a fluoroethylene-vinyl ether copolymer, and a poly(chlorotrifluoroethylene).

5. A method for producing a press-bonded body, comprising a step 1 of
press-bonding at least one of a base material selected from the group consisting of non-woven fabric, stretched porous film, and fiber
in the presence of polytetrafluoroethylene particles, and
carbon dioxide in a liquid state, a gas-liquid mixture state, or a nearly liquid state.

6. The method for producing a press-bonded body according to claim 5, in which the step 1 is
a step 1a in which at least one of a base material selected from the group consisting of non-woven fabric, stretched porous film, and fiber, and a polytetrafluoroethylene dispersion are brought into contact with liquid or gaseous carbon dioxide, and is pressurized, or
a step 1b in which at least one selected from the group consisting of non-woven fabric, stretched porous film, and fiber is brought into contact with a polytetrafluoroethylene dispersion, and is subsequently dried to obtain a dried body, and the dried body is brought into contact with liquid or gaseous carbon dioxide and is pressurized.

7. The method for producing a press-bonded body according to claim 5, in which the press-bonded body has a structure such that polytetrafluoroethylene fibrils bond the base material.

8. The method for producing a press-bonded body according to claim 7, in which the proportion of the number of fibrils that are oriented at an angle of 0° to 45° relative to the press-bonding direction is 50% or greater in relation to the entirety of the fibrils.

9. The method for producing a press-bonded body according to claim 5, in which the polytetrafluoroethylene content in the press-bonded body is 0.2% to 12% by mass in relation to 100% by mass of the base material in the press-bonded body.

10. The method for producing a press-bonded body according to claim 7, in which the average fiber diameter of the fibrils is from 10 nm to 1 μm.

11. The method for producing a press-bonded body according to claim 5, in which the base material comprises at least one of a fluorine resin selected from the group consisting of a tetrafluoroethylene-perfluoroalkyl vinyl ether copolymer, a tetrafluoroethylene-hexafluoropropylene copolymer, an ethylene-tetrafluoroethylene copolymer, a tetrafluoroethylene-hexafluoropropylene-perfluoroalkyl vinyl ether copolymer, a fluoroethylene-vinyl ether copolymer, and a poly(chlorotrifluoroethylene).
